(19) United States
(12) Patent Application Publication
(10) Pub. No.: US 2025/0050775 A1
(43) Pub. Date: Feb. 13, 2025

(54) METHOD AND CONTROL DEVICE FOR ELECTRICALLY CHARGING AN ENERGY STORAGE OF A MOTOR VEHICLE

(71) Applicant: AUDI AG, Ingolstadt (DE)

(72) Inventors: Florian AUBERGER, Kösching (DE); Tobias ENZINGER, Hohenwart (DE); Philipp GRIESSL, Eggstätt (DE); Patrick SCHUSTER, Langenbrettach (DE)

(73) Assignee: AUDI AG, Ingolstadt (DE)

(21) Appl. No.: 18/795,593

(22) Filed: Aug. 6, 2024

(30) Foreign Application Priority Data
Aug. 11, 2023 (DE) 102023121551.5

(51) Int. Cl. B60L 53/62; B60L 58/26

(52) U.S. Cl. CPC B60L 53/62; B60L 58/26; B60L 2250/00

(57) ABSTRACT

A method for electrically charging an energy storage of a motor vehicle at an electrical energy source external to the vehicle from a specific initial charge state of the energy storage to a specific final charge state of the energy storage. A control device controls the charging according to the first charging mode such that the energy storage is charged by the external energy source with a first charging power and according to a first overall efficiency. In addition, the control device determines whether an activation request made by a user to activate a second charging mode, which represents an energy saving mode, has been received, and at least if this is the case, the control device controls the charging process according to a second charging mode.

### FIELD

The invention relates to a method for electrically charging an energy storage of a motor vehicle at an electrical energy source external to the vehicle from a specific initial charge state of the energy storage to a specific final charge state of the energy storage, wherein, in the event that a first charging mode is set, a control device controls the charging according to the first charging mode such that the energy storage is charged by the external energy source from the initial charge state to the final charge state with a first charging power and according to a first overall efficiency, which relates to the ratio of a first amount of energy stored in the energy storage during charging from the initial charge state to the final charge state to a second amount of energy obtained from the energy source. The invention furthermore also relates to a control device for a motor vehicle.

### BACKGROUND

It is known from the prior art that electric vehicles can carry out fast charging processes. This refers to charging processes with very high charging power. Such fast charging processes can therefore be carried out in a very short time. This fast charging is usually designed on the vehicle side in such a way that charging occurs at the maximum possible speed. The vehicle therefore demands the maximum technically feasible charging current from the charging station. However, high charging power also leads to increased energy losses during charging, which must also be paid for by the user. Accordingly, it is also known from the prior art that a user can specify specific charging priorities, for example charging with maximum cost efficiency.

For example, DE 10 2017 116 418 A1 describes a system comprising an electrified vehicle with a battery pack, a human-machine interface configured to receive inputs for setting a charging profile, and a controller. The system further comprises a battery system that selectively charges the battery pack in response to an instruction from the controller. In addition, the controller is designed to instruct the battery system to charge the battery pack in accordance with the charging profile. The inputs for setting the charging profile can comprise a selection of at least one cell that corresponds to a desired charging time and desired electricity costs.

Furthermore, U.S. Pat. No. 9,853,488 B2 describes an electric charging system with a vehicle sensor, a communication device and a processor which, depending on a charging preference specified by a user of the vehicle, determines a charging sequence for charging the vehicle and carries out the charging accordingly. The charging preference can be used to specify that the vehicle should be charged to a specific percentage of its total capacity by a specific time or that the vehicle should be charged to a specific level in order to be able to drive a specific distance.

In principle, it is possible for a user to specify various requirements regarding the charging process or to set priorities. However, this makes each charging process very laborious, time-consuming and complex for a user.

### SUMMARY

The object of the present invention is therefore to provide a method and a control device which enable the most efficient possible charging of an energy storage, while ensuring the greatest possible operating and charging convenience.

This object is achieved by a method and a control device with the features according to the respective independent claims. Advantageous embodiments of the invention are the subject matter of the dependent claims, the description, and the figures.

In a method according to the invention for electrically charging an energy storage of a motor vehicle at an electrical energy source external to the vehicle from a specific initial charge state of the energy storage to a specific final charge state of the energy storage, wherein, in the event that a first charging mode is set, a control device controls the charging according to the first charging mode such that the energy storage is charged by the external energy source from the initial charge state to the final charge state with a first charging power and according to a first overall efficiency, which relates to the ratio of a first amount of energy stored in the energy storage during charging from the initial charge state to the final charge state to a second amount of energy obtained from the energy source. Furthermore, the control device checks whether an activation request made by a user to activate a second charging mode, which represents an energy-saving mode, has been received, and under the first condition that the control device determines that the activation request has been received, the control device activates the second charging mode and controls the charging process according to the second charging mode such that the energy storage is charged by the vehicle-external energy source from the initial charge state to the final charge state according to a second overall efficiency that is higher than the first overall efficiency and lower than a specific maximum possible overall efficiency.

The invention is based on several findings: In the early days of electromobility, the charging powers and ranges of electric vehicles were comparatively small. That is why fast charging processes have been designed to charge with the maximum possible charging power in order to reduce the charging time to a minimum. However, significantly higher charging powers and ranges can already be achieved and in the coming years these charging powers and ranges will continue to develop. Charging times are now less than 25 minutes for charging from 10% capacity or for charging to a 80% charge state. However, these very high charging powers lead to increased energy losses during charging. in particular in the area of these already achievable, very short charging times, the fastest possible performance is no longer always required to carry out a charging process, since sometimes charging stops, for example due to a coffee break, going to the toilet, travel time and so on, would be longer anyway, for example 30 minutes, in particular because the distances that can be covered with one charge are also increasing. In many cases, a small extension of the charging time would not affect the comfort for the user anyway, but on the other hand, even a small extension of the charging time, in particular by a small reduction in the charging power, can already reduce the overall power loss and thus save energy loss and expenses during charging. in particular when charging, in particular DC charging, with very high charging power, there is an increased energy loss due to the internal battery resistance of the energy storage, and an increased energy loss due to the thermal management for cooling the energy storage during the charging process, as well as a specific but minor power loss due to the on-board network. The invention now uses these findings to provide an eco mode, namely the second charging mode, according to which the energy storage can be charged more energy efficiently, i.e. with higher efficiency, without significantly or noticeably extending the overall charging time. In other words, according to this second charging mode, charging should not take place with the maximum possible efficiency, which could potentially lead to a very long extension of the charging time, but with a predetermined moderate increase in efficiency, so that on the one hand the power loss can be reduced and on the other hand the charging time is only slightly extended overall. The extension of the charging time does not result in any significant loss of comfort for the user and at the same time energy can be saved. To activate such an eco charging mode, for example, it is sufficient for the user to operate a corresponding control element to signal the activation request. The user therefore does not have to set complex specifications regarding a charging profile. In the simplest case, an Eco button can be provided in the vehicle, which the user can press before or during a charging process, for example, to activate the Eco charging mode. The invention therefore makes it possible to combine a very high level of operating comfort and charging convenience for a user with an increase in charging efficiency.

The battery can be, for example, a battery of a motor vehicle, in particular a high-voltage battery. The vehicle-external electrical energy source can be a charging station or charging column or a wall box or something similar. In addition, the vehicle-external energy source can be a public charging facility or a private charging facility. In the context of the present invention, the energy storage is preferably charged using direct current, i.e. DC charging. in particular with direct current charging, very high charging powers can be provided and in particular in the case of very high maximum possible charging powers, the second charging mode is very efficient.

The charging time from which charging begins from the initial charge state of the energy storage does not necessarily have to represent the start time of the charging process itself, although this is still possible. In other words, the second charging mode can also be activated while a charging process is already in progress. Accordingly, the charge state of the energy storage at this activation time corresponds to the initial charge state of the energy storage. The charge states of the energy storage, i.e. the initial charge state and the final charge state, can refer to a percentage value based on the total capacity of the energy storage. The charge state is often referred to as SOC (State of Charge) and is given in percent. The final charge state can also be specified by a user. The final charge state can also be predetermined by the control device if not specified in more detail by the user. The activation request to activate the second charging mode can be communicated by the user via a control element of the control device, as explained in more detail later. The activation request can therefore be provided in the form of a corresponding activation signal and received by the control device. Furthermore, such a control element, in particular a real and/or virtual control element, for example in the form of an operating menu or an operating display on a touchscreen, can be provided by the motor vehicle itself or by a mobile communication device of the user or by an app (application program) that can run on such a mobile communication device.

The first charging power with which charging takes place according to the first operating state can refer to a maximum possible charging power. The maximum possible charging power represents the charging power that can, from a technical point of view, be implemented by the external energy source and the motor vehicle. In other words, this represents the lower of the two charging powers that can be achieved by the external energy source on the one hand and the vehicle on the other.

A charging power, namely the first charging power as well as the second charging power mentioned later, should also be understood as a charging power value, namely a value of the charging power. The fact that the second charging power mentioned later is smaller than the first charging power or is reduced compared to it can accordingly mean that the charging power value of the first charging power is smaller than the charging power value of the second charging power. The term first or second charging power can also be understood as at least one first or second charging power. The first or second charging power can vary from the initial state to the final state during the charging process.

In general, the charging power does not have to be constant during a charging process. The first charging power can, for example, refer to a first maximum charging power value that is reached during the charging process, to a first charging power curve that includes several, in particular also different, chronologically successive first charging power values, in particular all chronologically successive power values that are assumed during charging from the initial charge state to the final charge state, and/or to an average first charging power, for example as the average value of the first charging power curve. The same applies to the second charging power, as will be explained in more detail later. The first or second charging power can also be understood as a temporal charging power variation of the first or second charging power, i.e. a first charging power curve or a second charging power curve.

A charging process according to the second charging mode, in which charging is carried out with a higher efficiency than the first overall efficiency, but with a lower overall efficiency than a specific maximum possible efficiency, can be implemented in a simple manner according to an example by reducing the maximum possible charging power, namely the first charging power, but not minimizing it, i.e. by not setting it to the minimum possible charging power value for the charging process. This avoids an inappropriate restriction to extremely low charging power.

An overall efficiency, namely the first and second and maximum possible overall efficiency, should also be understood as an efficiency value of the efficiency, namely a value of the overall efficiency. In general, overall efficiency is understood to mean efficiency according to the usual definition. Both the first and the second overall efficiency indicate the ratio between the first amount of energy charged into the energy storage during the charging process from the specific initial state to the specific final state to the second amount of energy obtained from the external energy source. These two amounts of energy differ in the amount of energy loss that can be caused by the components described above. The fact that the second overall efficiency is higher than the first overall efficiency means that during an (identical) charging process according to the second charging mode, the energy losses are reduced compared to an otherwise identical charging process according to the first charging mode.

The control device can preferably represent a vehicle-internal control device, namely the control device is part of the motor vehicle. However, the control device can also be a control device external to the vehicle that can communicate with the motor vehicle via a communication connection.

In a further, very advantageous embodiment of the invention, the activation, in particular an effective activation, of the second charging mode only takes place under the second condition that a maximum possible charging power for the electrical charging, which corresponds in particular to the first charging power, is greater than a predetermined threshold value. The predetermined threshold value may generally lie within a limit power interval having a lower limit and an upper limit.

The lower limit of the limit power interval can be, for example, between 30 kilowatts and 100 kilowatts, or, for example, between 40 kilowatts and 80 kilowatts, or, for example, between 40 kilowatts and 60 kilowatts, or, for example, between 45 kilowatts and 55 kilowatts inclusive.

The upper limit of the power interval, which is greater than the lower limit, can be, for example, between 70 kilowatts and 250 kilowatts inclusive, or, for example, between 80 kilowatts and 200 kilowatts inclusive, or, for example, between 80 kilowatts and 150 kilowatts inclusive, or, for example, between 85 kilowatts and 120 kilowatts inclusive, or, for example, between 90 kilowatts and 120 kilowatts inclusive, or, for example, between 90 kilowatts and 110 kilowatts inclusive.

The predetermined threshold value can generally be in a limit power interval from 40 KW to 250 kilowatts inclusive, or in a limit power interval from 40 KW to 220 kilowatts inclusive, or in a limit power interval from 40 KW to 200 kilowatts inclusive, or in a limit power interval from 40 KW to 150 kilowatts inclusive, or in a limit power interval from 40 KW to 120 kilowatts inclusive, or for example in a limit power interval from 40 kilowatts to 100 kilowatts inclusive, or for example in a limit power interval from 40 kilowatts to 80 kilowatts inclusive, for example at 50 kilowatts.

This is particularly advantageous because the benefits of the second charging mode are particularly noticeable at very high charging powers. With charging powers already low, no significant energy savings can be achieved anyway, so that only an unnecessary extension of the charging time would have to be accepted. This can advantageously be avoided. However, in particular at very high charging powers, a slight reduction in the charging power only leads to a very small increase in the charging time, for example in the single-digit minute range, while at the same time a lot of wasted energy can be saved.

In the event that the maximum possible charging power is less than the predetermined threshold value, it may be provided according to a less preferred embodiment that the user is not provided with any opportunity to express the activation request. For example, a control element displayed on a touchscreen, namely a touch screen, and associated with the energy saving mode may not be operable, namely it would not trigger a function when actuated, for example, when touched by the user or at least it would not trigger the function of signaling the activation request to the control device, and it would for example be grayed out, or even not displayed at all. When the control element that is not actually operable is operated, the user can be informed that the energy saving mode cannot currently be activated or is not available.

However, it is preferred that the user is always given the opportunity to express the activation request by operating a control element, and that, for example, the second charging mode is then also displayed to the user as activated, wherein the activation of the second charging mode is effective first, or preferably the activated second charging mode only becomes effective starting from the above-mentioned threshold value. The second charging mode can therefore also be activated if the maximum possible charging power falls below the threshold value, but the effectiveness of the second charging mode only comes into effect when the threshold value is exceeded.

For example, the user can activate the second charging mode using a control element, and this activation then remains permanent until deactivation occurs through another action by the user. While the second charging mode is activated or active, it does not have to be effective for every charging process, but only when the maximum possible charging power during such a charging process reaches or exceeds the threshold value.

In a further advantageous embodiment of the invention, when the second charging mode has been activated, the control device controls the charging process according to the second charging mode such that the energy storage is charged by the external energy source from the initial charge state to the final charge state with a second charging power that is reduced compared to the first charging power, in particular wherein before the start of the charging process according to the second charging mode, the control device predicts an expected charging time depending on the second charging power and outputs the prediction to the user via an output device.

As already mentioned, the start of the charging process according to the second charging mode does not have to coincide with the start of the overall charging process. For example, a charging process, for example from a second initial charge state to the first initial charge state, can also initially be carried out according to the first charging mode, and if the user then activates the second charging mode during this time, the control device can switch to the charging strategy according to the second charging mode and accordingly continue the charging process from the first initial charge state to the final charge state according to the second charging mode.

The fact that the first charging power is reduced compared to the second charging power can in this case be understood to mean that a temporal average or an initial value or a maximum value of the temporal charging power curve of the first charging power is smaller than the corresponding average or initial value or maximum value of the temporal charging power curve of the second charging power, or also that the entire second charging power curve is lower than the first charging power curve, for example for all power values corresponding to an identical charge state value of the energy storage.

By reducing the charging power, the power loss can be easily reduced. Preferably, the reduction in charging power is so low that it does not result in a significant extension of the charging time, for example an extension of the charging time of a maximum of 15 minutes or a maximum of ten minutes. The reduction of the charging power from the first charging power to the second charging power can, for example, be limited to a maximum of 30% relative to the first charging power, preferably less.

In addition, it is very convenient to show the user the “new” expected charging time according to this second charging mode. Based on this, the user can better decide whether or not he wants to accept this extension of charging time in favor of energy saving or whether he has this time available anyway.

The output device can represent an output device of the motor vehicle and/or an output device of a mobile communication device of the user. The charging time can also be communicated to the external energy source, for example a charging station, which in turn provides a corresponding display.

In a further very advantageous embodiment of the invention, according to the second charging mode for electrical charging, the maximum possible charging power, which in particular corresponds to the first charging power, is reduced in a predetermined manner, in particular by multiplying the maximum possible charging power by an efficiency factor. This efficiency factor is preferably greater than zero and less than one. By multiplying the maximum possible charging power by such a factor, the charging power can be reduced computationally in a particularly simple way or the new initial charging power can be determined. The efficiency factor is particularly preferably greater than 0.5, in particular greater than 0.6, or is at least 0.7. This allows only a slight reduction in the charging power in energy saving mode to be achieved.

In a particularly simple embodiment, this efficiency factor, in particular only a single such efficiency factor, is fixedly predetermined, i.e. independently of the maximum possible charging power. In a further very advantageous embodiment of the invention, an assignment is stored in a memory of the control device, which assigns a respective efficiency factor from a plurality of different efficiency factors to a plurality of different power ranges for the maximum possible charging power, wherein the control device selects the efficiency factor depending on the maximum possible charging power according to the assignment. It is also very advantageous if the assignment is designed in such a way that the efficiency factor is greater the lower the assigned maximum possible charging power is. For example, the efficiency factor for a charging power in the range between zero and 99 kilowatts can be 1. This means that the second charging mode is only effective from a maximum possible charging power of 100 kilowatts, since before the efficiency factor 1 does not reduce the maximum possible charging power. The second charging mode, for example, can always be activated, but it only has an effect or becomes effective when the charging power is, for example, at least 100 KW. For charging powers in the range between 100 kilowatts and 159 kilowatts, the efficiency factor can be, for example, 0.9, for charging powers in the range from 160 kilowatts to 219 kilowatts, it can be 0.8, and for maximum possible charging powers from 220 kilowatts, it can be 0.7, for example. Here, too, the corresponding efficiency factors can be specified as fixed values and stored in the assignment. This also makes it very easy to calculate the first charging power to be used for charging in accordance with the second charging mode. Preferably, only a few different charging power ranges, namely charging power value intervals, are defined, for example less than 10, in particular less than 5.

According to a further advantageous embodiment of the invention, a characteristic map is stored in a memory of the control device, which links the variables energy storage temperature, maximum possible charging power and efficiency factor, wherein the control device selects the efficiency factor depending on the maximum possible charging power and a current energy storage temperature of the energy storage according to the characteristic map. This advantageously also allows the temperature of the energy storage, which is referred to here as the energy storage temperature, to be taken into account. For example, this is the current temperature of the energy storage, for example at the time the energy saving mode is activated or at the time at which the user expresses his or her desire to activate it, for example by operating a control element. The characteristic map can therefore be structured like the assignment described above, wherein the temperature of the energy storage is taken into account as an additional input variable. A corresponding first charging power can be assigned to a value pair of energy storage temperature and maximum possible charging power using the characteristic map. For example, this first charging power can be determined according to the characteristic map such that the energy loss caused when charging according to this first charging power is reduced by x %, for example 20%, compared to the power loss that would occur when charging with the first charging power, i.e. the maximum possible charging power. This makes it possible to adapt the first charging power particularly well to the situation.

In a further advantageous embodiment of the invention, in order to activate the second charging mode by the user, a user input is received which specifies a charging time extension compared to a minimum possible charging time duration for a maximum possible charging power, and the control device determines a second charging power which is reduced compared to the first charging power as a function of the charging time extension and controls the charging process in the second charging mode according to the determined second charging power.

The first charging power corresponds to the maximum possible charging power. In other words, the first charging mode is designed to charge according to the maximum possible charging power. The maximum possible charging power mentioned in the following in connection with embodiments of the invention can thus be equated with the first charging power.

According to this advantageous embodiment of the invention, the user can, for example, select which charging time extension would be tolerable for him. For example, the user can make this adjustment via a slider, in particular a real or virtual one displayed on a touch screen. One can shift the charging time from the minimum possible charging time corresponding to the first charging power to his maximum tolerable charging time. This results in a charging time extension, depending on which the control device determines a corresponding second charging power, which is then selected such that when the charging process is carried out according to the second charging mode with this second charging power, the maximum tolerable charging time specified by the user through the charging time extension is not exceeded.

Charging time and charging time duration should be understood as synonymous terms. The charging time is the time from the initial point in time at which the supply of electrical energy to the energy storage by the vehicle-external energy source begins as part of the charging process, starting from the initial state of charge, to an end point in time at which the final charge state is reached. The charging time extension can be selected by the user by selecting a charging time that is extended relative to the minimum charging time, which refers to the charging time defined above, i.e. the total charging time of the charging process from the initial charge state to the final charge state, or by selecting a time difference that indicates how much the charging process is extended in time compared to the minimum charging time.

The user can make such a setting, for example, via an operating and display menu for charge control, for example via a charge select menu. To do this, the user activates a virtual charge select control element, for example, and then enters the charge select menu with the displayed virtual slider, for example, in order to set the maximum tolerable charging time extension. This also has the great advantage that the user is simultaneously shown the expected charging duration, i.e. the charging time.

According to a further advantageous embodiment of the invention, the control device receives a user input from the user for activating the second charging mode, which specifies a charging power which is reduced compared to a maximum possible charging power, wherein the control device then controls the charging process in the second charging mode according to the specified second charging power. Instead of specifying an extension of the charging time, the user can also directly set a reduction in the charging power via a corresponding menu. This can be done analogously to the charging time setting using a virtual slider. Thus, the maximum second charging power to be used according to the second charging mode can be directly specified by the user.

In this case, the charging power specified by the user should be understood to mean a single charging power value, in particular the second charging power. This may refer to a time average or an initial value or a maximum value of the time variation of the first charging power, preferably to a maximum value or time average value.

In a further advantageous embodiment of the invention, the control device provides a display on a display device, according to which various charging powers which are reduced compared to a maximum possible charging power can be displayed to the user, for example one after the other, wherein the associated estimated charging time is displayed for each currently displayed charging power. This is particularly advantageous in combination with the previously described embodiment, according to which the user is provided with the possibility of specifying the second charging power to be used. If a user selects such a reduced charging power, the associated predicted charging time can also be simultaneously displayed. If this time is considered too long, the user can immediately manually change the second charging power to be selected according to the second charging mode.

According to a further advantageous embodiment of the invention, in the second charging mode, a cooling capacity of a cooling system for cooling the energy storage during the charging process is limited or reduced to a second cooling capacity that is reduced compared to a maximum possible cooling capacity, in particular wherein the cooling system comprises an active cooling device and a passive cooling device, wherein the cooling capacity in the second charging mode is only provided by the passive cooling device and/or the active cooling device is deactivated or not activated during charging according to the second charging mode, or a cooling capacity provided by the active cooling device during charging in the second charging mode is reduced compared to the first charging mode.

A cooling system can consist of an active and a passive component. The cooling capacity can therefore generally be provided actively or passively. In active battery cooling, the battery is cooled via a refrigeration circuit using a compressor, particularly in a refrigeration process that achieves a high cooling performance. This is to a specific extent independent of the ambient temperature. However, this process requires a very high electrical power from the vehicle's compressor to provide the cooling capacity. There is also the so-called passive battery cooling, which is presently implemented by the passive cooling device. Here the battery is cooled via the vehicle's low-temperature cooler. This cooling function is highly dependent on the ambient temperature. The performance is lower than active battery cooling for outside temperatures above a system-specific limit, for example 0° C.

For the second charging mode, it can now be provided that, for example, passive cooling is forced by the control device and/or the cooling capacity is reduced to such an extent that passive cooling is automatically selected according to the selection logic previously implemented by the control device. In addition, it is conceivable that the passive cooling potential is communicated. In other words, based on the current ambient temperature, for example, it can be determined what maximum cooling capacity can currently be provided by the passive cooling device. Depending on this, for example, the second charging power can be determined in such a way that the charging process according to the second charging mode can be carried out in such a way that during this time only the passive cooling device or its cooling power is sufficient. For this purpose, for example, a corresponding, stored characteristic map can be used, which links the variables: external temperature, energy storage temperature and second charging power. This advantageous approach allows energy to be saved in two ways, namely not only by reducing the charging power itself, but also by selecting a particularly efficient charging power value for the second charging power, which is selected in such a way that the passive cooling function is just sufficient to carry out the charging process in accordance with the first charging power. As soon as active cooling is switched on, the energy loss increases abruptly simply by switching on this active cooling. By taking into account the cooling capacities of the respective cooling systems and in particular the ambient temperature, it is possible to select the first charging power specifically below this power loss jump.

The second charging power for carrying out the charging process in the second charging mode is preferably determined such that a maximum passive cooling power that can be provided by the passive cooling device as a function of a current ambient temperature and as a function of a current energy storage temperature and in particular as a function of a current coolant temperature is sufficient for carrying out the entire charging process according to the second charging power, and would not be sufficient for carrying out the entire charging process according to a third charging power that is higher by a predetermined value than the second charging power, wherein the predetermined value is less than a predetermined limit value, in particular less than 50 KW, in particular 10 KW. This allows the second charging power to be selected very close to the above-mentioned power loss jump.

In a further advantageous embodiment of the invention, the activation request is received by the control device in the form of a detection of an actuation of an operating element assigned to the second charging mode. Such a control element can be, for example, a physical switch or a button or lever or the like, or also a virtual control element, for example in the form of a displayed menu item that is displayed on a touchscreen, for example a touchscreen of the motor vehicle and/or a mobile communication device of the user. By operating a charge select control element, for example a menu item, the user can also access a submenu, the charge select menu, to activate the second charging mode by operating a corresponding control element. These could be, for example, the sliders described above.

In addition, it is conceivable that the second charging mode is divided into further sub-modes, for example a moderate and a strong energy saving mode. These can be designed so that the second efficiency associated with the moderate energy saving mode is lower than the second efficiency associated with the strong energy saving mode. However, both are still below the maximum possible efficiency. This provides even more flexibility. However, the number of subdivisions for the second efficiency is preferably limited to the low single-digit range, for example to two to three or a maximum of four selectable subgroups.

Furthermore, the invention also relates to a control device for a motor vehicle, which is designed to carry out a method according to the invention or one of its embodiments.

Furthermore, the invention also relates to a motor vehicle having a control device according to the invention or one of its embodiments.

The control device can have a data processing device or a processor device which is designed to perform an embodiment of the method according to the invention. For this purpose, the processor device can have at least one microprocessor and/or at least one microcontroller and/or at least one FPGA (Field Programmable Gate Array) and/or at least one DSP (Digital Signal Processor). In particular, a CPU (Central Processing Unit), a GPU (Graphical Processing Unit) or an NPU (Neural Processing Unit) can be used as a microprocessor. Furthermore, the processor device can have program code which is configured to carry out the embodiment of the method according to the invention when it is executed by the processor device. The program code can be stored in a data memory of the processor device. The processor device can be based, for example, on at least one circuit board and/or at least one SoC (System on Chip).

For applications or usage situations that can arise in the method and which are not explicitly described here, it can be provided according to the method, that a fault message and/or a request for input of user feedback is output and/or a standard setting and/or a predetermined initial status are set.

The invention also includes further developments of the control device according to the invention, which have features as have already been described in connection with the further developments of the method according to the invention. For this reason, the corresponding developments of the method according to the invention are not described again here.

The motor vehicle according to the invention is preferably designed as an automobile, in particular as a passenger car or truck, or as a passenger bus or motorcycle.

As a further solution, the invention also comprises a computer-readable storage medium, comprising program code which, when executed by a computer or a computer network, such as the control device, cause it to carry out an embodiment of the method according to the invention. The storage medium can be provided, for example, at least partially as a non-volatile data memory (such as a flash memory and/or as an SSD-solid state drive) and/or at least partially as a volatile data memory (such as a RAM-random access memory). The storage medium can be arranged in the computer or computer network. However, the storage medium can also be operated, for example, as a so-called app store server and/or cloud server on the Internet. A processor circuit having, for example, at least one microprocessor can be provided by the computer or computer network. The program code can be provided as binary code and/or as assembler code and/or as source code of a programming language (such as C) and/or as a program script (such as Python).

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In particular:

FIG. 1 shows a schematic representation of a motor vehicle which is charged at a charging station, according to an exemplary embodiment of the invention;

FIG. 2 shows a schematic flowchart to illustrate a method for charging an energy storage according to an exemplary embodiment of the invention;

FIG. 3 shows a schematic representation of a further flowchart to illustrate an exemplary embodiment of the invention.

FIG. 4 shows a schematic representation of an user interface for activating the energy saving mode according to an exemplary embodiment of the invention; and

FIG. 5 shows a schematic representation of two temporally successive displays of a user interface for activating the energy saving mode according to a further exemplary embodiment of the invention.

### DETAILED DESCRIPTION

The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, same reference numerals respectively designate elements that have the same function.

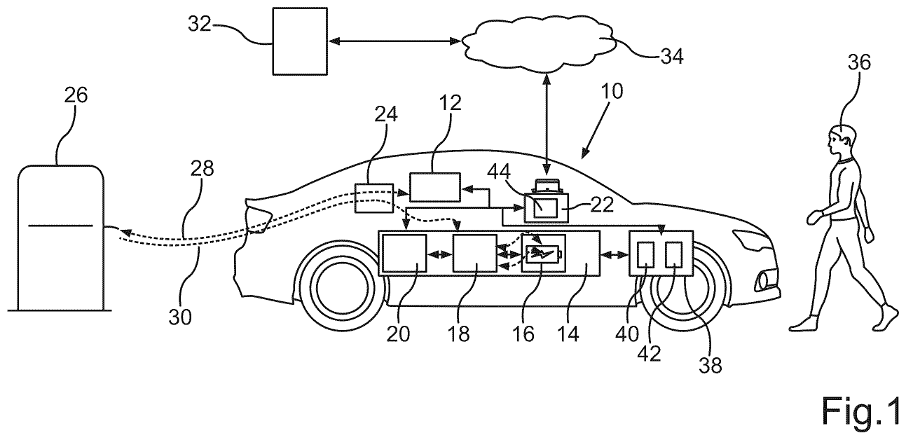

FIG. 1 shows a schematic illustration of a motor vehicle 10 having a control device 12 according to an exemplary embodiment of the invention. The motor vehicle 10 has an energy storage, for example a high-voltage battery 14. This comprises several battery cells 16, for example lithium-ion cells. In addition, the high-voltage battery also comprises an electronics box 18 and a battery control unit 20, which can also be referred to as a battery management system. The motor vehicle further comprises an infotainment system 22 and a charging socket 24, via which the motor vehicle 10, in particular the battery 14, can be coupled to the vehicle-external energy source, which in the present example represents a charging station 26. The coupling of the vehicle 10 with the charging station 26 can take place via one or more lines, via which on the one hand digital communication is provided, which in the present case is provided by the communication line 28 shown as an example, and via which electrical energy is transmitted, as in the present example by the power line 30 shown as an example. These lines 28, 30 can be integrated into a charging cable, via which the vehicle 10, in particular the charging socket 24, can be coupled to the charging station 26. The infotainment system 22 also enables communication via a smartphone app 32, in particular via a cloud server 34. The smartphone app 32 can run on a mobile communication device of a user of the motor vehicle 10. The user is presently referred to as 36. In addition, the vehicle 10 also includes a thermal system 38. This can include an active cooling device 40 and a passive cooling device 42. The energy storage 14 can be cooled or temperature-controlled via these cooling devices 40, 42, in particular during a charging process.

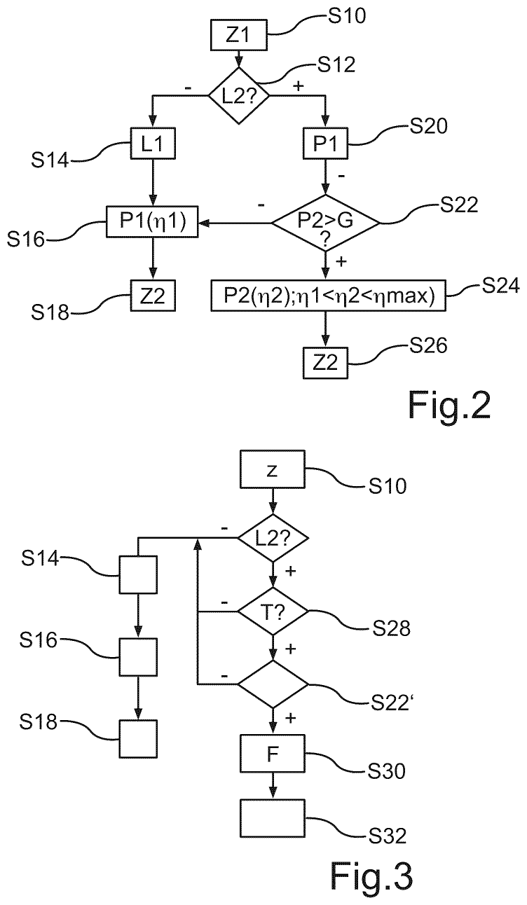

FIG. 2 shows a flowchart to illustrate a method for charging the energy storage 14 according to an exemplary embodiment of the invention. The method starts in step S10, in which the energy storage 14 has an initial charge state Z1 and is to be charged. Before starting the charging process, the control device 12 checks in step S12 whether an activation request to activate the energy saving mode L2 has been received from the user. The latter can express or enter the energy saving mode L2 via a suitable interface, for example via the app 32 or an operating device 44 (see FIG. 1) of the motor vehicle 10. If no such activation request was received, the control device 12 activates a first charging mode L1 for the subsequent charging process in step S14. Furthermore, in step S16, the control device determines a maximum possible charging power P1 for this first charging mode L1, from which a first overall efficiency η1 results for the charging process to be carried out. Subsequently, in step S18, the energy storage 14 is charged according to this first charging power P1 up to the desired, predetermined final charge state Z2.

However, if it is determined in step S12 that the user wishes to activate the energy saving mode L2, the control device 12 first determines in step S20 the maximum possible charging power P1 for the charging process to be carried out. It then checks in step S22 whether this maximum possible charging power P1 is greater than a predetermined limit value G, for example 50 kilowatts. If this is not the case, the process goes to step S16. If this is the case, the system goes to step S24, according to which a second charging power P2 is selected, to which a second efficiency η2 is assigned, which is greater than the first efficiency η1, but smaller than a maximum possible efficiency ηmax. Subsequently, the charging process is carried out in step S26 with this slightly reduced charging power P2 until the final charge state Z2 is reached.

There are several ways to determine this second charging power P2, which are explained in more detail below.

FIG. 3 shows a flowchart to illustrate a method according to a further exemplary embodiment of the invention. This method in turn starts a step S10, in which the energy storage 14 is to be charged starting from its initial charge state Z1. In step S12, it is again checked whether the energy saving mode or efficiency mode L2 is active or whether a corresponding activation request has been received from the user 36. If this is not the case, the conventional charging process is carried out according to steps S14, S16 and S18 already described in FIG. 2. Otherwise, in this example, it is first checked in step S28 whether the battery temperature T, i.e. the temperature of the energy storage 14, is in a specific target range, for example between 5° Celsius and 35° Celsius. If this is not the case, the conventional charging process is resumed according to steps S14, S16 and S18. Otherwise, the system goes to step S22′, where it can again be checked whether the maximum possible charging power P1 is above a specific limit value G, or within a specific range of values, for example between 50 kilowatts and 280 kilowatts. An upper limit, in this case 280 kilowatts, is only optional and can, for example, correspond to the maximum possible charging power P1.

If this is not the case, the conventional charging process is resumed according to steps S14, S16 and S18. Otherwise, the system proceeds to step S30, in which an efficiency factor F is determined, in particular from a characteristic map stored in the memory of the control device 12. This characteristic map is spanned by the battery starting temperature T and the maximum possible charging power P1 and outputs a corresponding factor F for each of these pairs of values. Subsequently, in step S32, the vehicle or the energy storage 14 is charged with a maximum charging power reduced by X %, namely with the second charging power P2. The X % results from the percentage representation of the determined factor F. The second charging power can be determined, for example, according to the following formulas:

$${P}_{Lade , max , neu} = {P}_{Lade , max} \cdot \frac{( 100 - X )}{100}$$

P_{lade,max} represents the maximum charging power currently possible in the combination of vehicle and charging station, which corresponds to the described first charging power P1, and P_{lade,max,neu} represents the maximum charging power that can be implemented after applying the efficiency factor, i.e. the second charging power P2. X is the percentage representation of the efficiency factor F. For example, an efficiency factor F of 0.9 corresponds to 90%.

The charging manager or the control device 12 then throttles the charging power P1 requested from the charging station 26 by a corresponding efficiency factor F.

In this example, the user 36 can first select the efficient charging function L2 in the infotainment system 22, for example, and the infotainment system 22 sends this request to the charging manager, i.e. the control device 12, which then carries out the subsequent steps already described. For example, the efficiency factor F can have been calculated in the characteristic map in such a way that the energy loss resulting from the second charging power is 20% below the original value at the respective maximum charging power P1. In addition, after determining the efficiency factor F, the corresponding predicted charging duration can also be determined and displayed to the user. In principle, the user 36 is always provided with the option to cancel the energy saving mode L2 and switch back to the normal first charging mode L1.

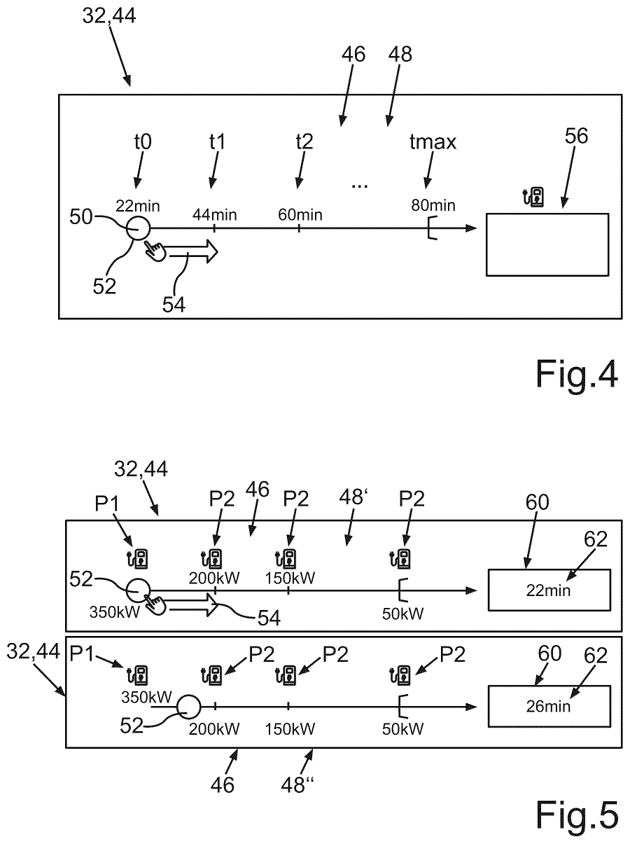

FIG. 4 shows a schematic representation of a user interface 46, as this can be displayed to the user, for example in the form of a charge select menu, by the app 32 or the output device 44 of the motor vehicle 10, for activating the energy saving mode L2. Beforehand, the user 36 may have started the charging process as usual or plugged in the charging cable and initially receives information about how long the usual charging process on the connected infrastructure 26 will take. For example, the text “the charging process will take about 22 minutes” can be displayed. For example, if the user 36 has more time anyway, he can open the App 32 or the corresponding menu on the display device 44 in vehicle 10. With these interfaces 32, 44, one can open the charge indicators and for example press a button “charging time extension” to get to this currently illustrated display 48. This gives the user the opportunity to extend the charging process depending on the current charging power. The reference value in this example is the target time, and the charging speed per power is then determined from the target time setting. The starting point 50 represents the minimum achievable charging time to corresponding to the maximum charging power P1. tmax corresponds to the maximum charging time resulting from an adjustable minimum charging power P2. The user can be shown a virtual slider 52 which can be moved, with this movement being visualized by the arrow 54. By moving the slider 52 the charging time can be extended accordingly. Optionally, the average or maximum expected charging power 56 can also be displayed for each current charging time setting t1, t2.

Advantages can be achieved in terms of battery protection due to the lower charging power and through increased efficiency, i.e. through lower charging losses. The extension of the charging time is preferably only possible for charging powers greater than a specific limit value, for example 50 kilowatts. The function preferably automatically resets to the minimum charging time t0 after charging is complete.

FIG. 5 shows a schematic representation of two further, cronologically successive displays 48′, 48″ during or for activation of the energy-saving mode L2 according to another exemplary embodiment of the invention. The user 36 can select the minimum charging target time indirectly, in particular again via the slider 52 already described. However, the charging time extension is not set directly, but the user 36 can directly select the second charging power P2 from several possible values P2 by moving 54 the slider 52. For each selectable value P2, the user is also shown the predicted charging time 62 on a corresponding display 60. The upper illustration in FIG. 5 corresponds to the display 48′, which is displayed when the maximum charging power P1 is selected. Based on this, the user then moves the slider 52 in the direction of a lower charging power P2, as shown in the lower illustration in FIG. 5. As a result, the charging time 62 is extended accordingly, as in the present example, from 22 minutes to 26 minutes, i.e. by four minutes.

The customer or user has the option of extending the charging process depending on the current charging power P1, P2. The reference variable here is the permissible maximum charging power P1, P2 and the charging time 62 and charging speed result from the available charging power P1, the power limitation to the second charging power P2. The advantages are the same as described previously. This function is retained, for example, as a preset for subsequent charging processes or can be automatically reset to the original setting after the charging process has been completed. The infotainment 22 then sends the new minimum charging target time 62 to the charging manager 12 and the charging manager 12 implements the minimum charging target time 62 as follows: This determines the optimal charging curve taking into account the maximum permissible power provided by the second charging power P2.

Overall, the examples show how the invention can provide a method for increasing the efficiency and convenience of DC fast charging. The user gets an “efficient charging function” to choose from when charging. When this is activated, the maximum charging power is throttled so that the user can save for example at least 20% of the charging energy that would otherwise be lost. If the user can afford a longer charging break than usual, the efficient charging function can be easily activated via MMI (multi-media interface of the vehicle) or mobile phone. Implementation via a characteristic map does not require extensive computing power. A saving of 20% in lost energy can be achieved when reaching the target SOC of 80%, for example. It also enables simple setting for all charging scenarios, easy comprehension by the user, and ensures a minimum charging speed.

1. A netgid for electrically charging an energy storage of a motor vehicle at an electrical energy source external to the vehicle, from a specific initial charge state of the energy storage to a specific final charge state of the energy storage, comprising:
in the event that a first charging mode is set, a control device controls the charging according to the first charging mode such that the energy storage is charged by the external energy source from the initial charge state to the final charge state with a first charging power and according to a first overall efficiency which relates to the ratio of a first amount of energy stored in the energy storage during charging from the initial charge state to the final charge state to a second amount of energy obtained from the energy source,
wherein the control device checks whether an activation request made by a user to activate a second charging mode, which represents an energy saving mode, has been received, and
under the first condition, that the control device determines that the activation request has been received, the control device activates the second charging mode and controls the charging process according to the second charging mode such that the energy storage is charged by the external energy source from the initial charge state to the final charge state according to a second overall efficiency which is higher than the first overall efficiency and lower than a specific maximum possible overall efficiency.

2. The method according to claim 1, wherein the activation, in particular an effective activation, of the second charging mode only takes place under the second condition that a maximum possible charging power for electrical charging, which corresponds in particular to the first charging power, is greater than a predetermined threshold value, which is in particular between 40 KW and 100 KW inclusive, for example between 40 KW and 80 KW inclusive.

3. The method according to claim 1, wherein when the second charging mode has been activated, the control device controls the charging process according to the second charging mode such that the energy storage is charged by the external energy source from the initial charge state to the final charge state with a second charging power that is reduced compared to the first charging power, wherein before the start of the charging process according to the second charging mode, the control device predicts an estimated charging time depending on the second charging power and outputs it to the user via an output device.

4. The method according to claim 1, wherein according to the second charging mode, a maximum possible charging power for electrical charging, which in particular represents the first charging power, is reduced in a predetermined manner, in particular by multiplying the maximum possible charging power by an efficiency factor, in particular
wherein an assignment is stored in a memory of the control device, which assignment assigns a respective one of a plurality of efficiency factors to a plurality of different power ranges for the maximum possible charging power, wherein the control device selects the efficiency factor depending on the maximum possible charging power according to the assignment; and/or
wherein a characteristic map is stored in a memory of the control device which map links the variables energy storage temperature, maximum possible charging power and efficiency factor, wherein the control device selects the efficiency factor depending on the maximum possible charging power and on a current energy storage temperature of the energy storage according to the characteristic map.

5. The method according to claim 1, wherein for activating the second charging mode by the user, a user input specifying a charging time extension compared to a minimum possible charging time for a maximum possible charging power is received by the control device, and the control device determines a second charging power reduced compared to the first charging power as a function of the charging time extension and controls the charging process in the second charging mode according to the determined second charging power.

6. The method according to claim 1, wherein for activating the second charging mode by the user, a user input specifying a charging power that is reduced compared to a maximum possible charging power is received by the control device, and the control device controls the charging process in the second charging mode according to the specified second charging power.

7. The method according to claim 1, wherein the control unit provides a display on an output device, according to which different second charging powers which are reduced compared to a maximum charging power can be displayed to the user, wherein the associated expected charging time is displayed for each displayed second charging power.

8. The method according to claim 1, wherein in the second charging mode, a cooling capacity of a cooling system for cooling the energy storage during the charging process is limited or reduced to a second cooling capacity that is reduced compared to a maximum possible cooling capacity, in particular wherein the cooling system comprises an active cooling device and a passive cooling device, wherein
the cooling capacity in the second charging mode is provided only by the passive cooling device and/or the active cooling device is deactivated during charging according to the second charging mode; or
a cooling power provided by the active cooling device during charging in the second charging mode is reduced compared to the first charging mode.

9. The method according to claim 1, wherein the activation request is received in the form of a detection of an actuation of a control element assigned to the second charging mode by the control device.

10. A control device for a motor vehicle, which is designed to carry out a method according to claim 1.

11. The method according to claim 2, wherein when the second charging mode has been activated, the control device controls the charging process according to the second charging mode such that the energy storage is charged by the external energy source from the initial charge state to the final charge state with a second charging power that is reduced compared to the first charging power, wherein before the start of the charging process according to the second charging mode, the control device predicts an estimated charging time depending on the second charging power and outputs it to the user via an output device.

12. The method according to claim 2, wherein according to the second charging mode, a maximum possible charging power for electrical charging, which in particular represents the first charging power, is reduced in a predetermined manner, in particular by multiplying the maximum possible charging power by an efficiency factor, in particular
wherein an assignment is stored in a memory of the control device, which assignment assigns a respective one of a plurality of efficiency factors to a plurality of different power ranges for the maximum possible charging power, wherein the control device selects the efficiency factor depending on the maximum possible charging power according to the assignment; and/or
wherein a characteristic map is stored in a memory of the control device which map links the variables energy storage temperature, maximum possible charging power and efficiency factor, wherein the control device selects the efficiency factor depending on the maximum possible charging power and on a current energy storage temperature of the energy storage according to the characteristic map.

13. The method according to claim 3, wherein according to the second charging mode, a maximum possible charging power for electrical charging, which in particular represents the first charging power, is reduced in a predetermined manner, in particular by multiplying the maximum possible charging power by an efficiency factor, in particular
wherein an assignment is stored in a memory of the control device, which assignment assigns a respective one of a plurality of efficiency factors to a plurality of different power ranges for the maximum possible charging power, wherein the control device selects the efficiency factor depending on the maximum possible charging power according to the assignment; and/or
wherein a characteristic map is stored in a memory of the control device which map links the variables energy storage temperature, maximum possible charging power and efficiency factor, wherein the control device selects the efficiency factor depending on the maximum possible charging power and on a current energy storage temperature of the energy storage according to the characteristic map.

14. The method according to claim 2, wherein for activating the second charging mode by the user, a user input specifying a charging time extension compared to a minimum possible charging time for a maximum possible charging power is received by the control device, and the control device determines a second charging power reduced compared to the first charging power as a function of the charging time extension and controls the charging process in the second charging mode according to the determined second charging power.

15. The method according to claim 3, wherein for activating the second charging mode by the user, a user input specifying a charging time extension compared to a minimum possible charging time for a maximum possible charging power is received by the control device, and the control device determines a second charging power reduced compared to the first charging power as a function of the charging time extension and controls the charging process in the second charging mode according to the determined second charging power.

16. The method according to claim 4, wherein for activating the second charging mode by the user, a user input specifying a charging time extension compared to a minimum possible charging time for a maximum possible charging power is received by the control device, and the control device determines a second charging power reduced compared to the first charging power as a function of the charging time extension and controls the charging process in the second charging mode according to the determined second charging power.

17. The method according to claim 2, wherein for activating the second charging mode by the user, a user input specifying a charging power that is reduced compared to a maximum possible charging power is received by the control device, and the control device controls the charging process in the second charging mode according to the specified second charging power.

18. The method according to claim 3, wherein for activating the second charging mode by the user, a user input specifying a charging power that is reduced compared to a maximum possible charging power is received by the control device, and the control device controls the charging process in the second charging mode according to the specified second charging power.

19. The method according to claim 4, wherein for activating the second charging mode by the user, a user input specifying a charging power that is reduced compared to a maximum possible charging power is received by the control device, and the control device controls the charging process in the second charging mode according to the specified second charging power.

20. The method according to claim 5, wherein for activating the second charging mode by the user, a user input specifying a charging power that is reduced compared to a maximum possible charging power is received by the control device, and the control device controls the charging process in the second charging mode according to the specified second charging power.
